(19) United States
(12) Patent Application Publication
(10) Pub. No.: US 2019/0078274 A1
(43) Pub. Date: Mar. 14, 2019

(54) METHOD FOR AIRFIELD ASSESSMENTS AND PREDICTIVE MAINTENANCE

(71) Applicant: JOHN S. MCNEEELY, ADAMS CENTER, NY (US)

(72) Inventor: JOHN S. MCNEEELY, ADAMS CENTER, NY (US)

(21) Appl. No.: 16/045,386

(22) Filed: Jul. 25, 2018

Related U.S. Application Data
(60) Provisional application No. 62/536,759, filed on Jul. 25, 2017.

(51) Int. Cl. E01C 23/01; G01N 21/55; G06Q 30/00; G06Q 10/00

(52) U.S. Cl. CPC E01C 23/01; G01N 21/55; E01F 9/576; G06Q 10/20; G06Q 30/018

(57) ABSTRACT

A method of airfield markings assessment and scheduling predictive maintenance periodically measures characteristics of individual portions of an airport's runways, and identifies the measured locations. The periodic individual portion measurements the airfield's runways and such measurements at similar airfields' runways are used to determine projections of how long the runway's individual marking portions will separately comply with FAA's marking requirements and the results used to schedule a predictive maintenance program which periodically removes and replaces less than all of the runway's markings.

This application is based upon and claims priority from U.S. Provisional application Ser. No. 62/536,759, filed Jul. 25, 2017, which is incorporated herein by reference.

### BACKGROUND OF THE INVENTION

### Field of the Invention

Applicant's invention relates to a method of airfield marking assessments and predictive maintenance of the markings.

### Background Information

The Federal Aviation Administration (“FAA”) has guidelines and standards for marking airport runways, taxiways, and aprons. As used herein, “runway” is sometimes used to include all airfield runways, taxiways, aprons, and roadways where markings are found and any FAA regulated marked pavement. The FAA's standards for marking airport runways are stated in Title 14 Code of Federal Regulations Part 139, Certification of Airports (Part 139). The FAA standards and its published regulations, guidelines and guidance are incorporated herein for all purposes. Compliance with the FAA's standards is required at all new airport projects. The FAA's standards are being implemented at existing Part 139 certificated airports. The FAA's standards are also mandatory for projects funded with federal grant monies through the Airport Improvement Program (AIP) or with revenue from the Passenger Facility Charge (PFC) Program. Thus, an airport administration's compliance with the FAA's standards for airport markings is extremely important.

The FAA standards require airport runway marking paints to meet certain brightness, reflectivity, width, color etc. standards. Because of the extreme use that airport markings are subjected to, airport administrations must recoat/repaint the markings to keep them in compliance with the FAA's standards. However, continually recoating and repainting an airport's runways is expensive.

The FAA requires that markings that are no longer needed be physically removed from the pavement to prevent the removed markings from having a continued visual appearance. It is not acceptable to simply paint over old markings. The FAA's requirements include specific patterns for removal of the old markings.

Markings at one part of the runway may be subjected to much more traffic and thus be more quickly damaged and suffer a higher level of deterioration than the markings at another part of the runway. However, the typical standard procedure has been that when any portion of the airport or of a runway falls below the FAA standards, the airport or runway's markings are entirely removed and recoated/repainted. This increases the lifecycle marking cost to the airport because it entails recoating/repainting portions of the airport markings that are in still compliance with the FAA standards along with portions that do need recoating/repainting. In sum, because FAA compliance is critical, typical standard procedure at many airports is to recoat/repaint markings based upon the needs of the most worn areas of markings and basing the extra airport or extra-runway marking compliance recoating/repainting schedule on those heavy traffic areas. As a result, lighter traffic areas with markings that are not yet in need of recoating/repainting are often repaired together with markings that do need to be replaced at a high and unnecessary cost.

Additionally, temporarily closing runways in order to recoat/repaint the markings results in lost use of the subject runway and increased use of other runways (which in turn further damages their markings) and potential lost revenue from the closing of the runway.

Instruments for mobile recording the retroreflectivity of markings on roadways are known. United States publication No. US 2016/0356005 discloses a truck which follows and records paint stripes on roadways. That publication additionally cites and briefly discusses other mobile vehicles which detect paint striping on roadways.

### SUMMARY OF THE INVENTION

A method is described herein of airfield markings assessment and scheduling predictive maintenance periodically measures characteristics of individual portions of an airport's runways, and identifies the measured locations. The periodic individual portion measurements the airfield's runways and such measurements at similar airfields' runways are used to determine projections of how long the runway's individual marking portions will separately comply with FAA's marking requirements and the results used to schedule a predictive maintenance program which periodically removes and replaces less than all of the runway's markings.

The markings of airport runways, taxiways and the like must meet rigorous FAA and ICAO requirements which are described more fully below. Runway markings have many important characteristics that may be measured, including color, width, continuity, relationship with other markings, i.e. parallel, tangential, distance apart etc., location, continuous or dashed, retroreflectivity, types of glass beads, amounts of glass beads, friction coefficient, that outdated markings have been sufficiently physically removed, black borders etc. Different runway markings, such as an aiming point marking, landing designator marking, touchdown zone marking, centerline marking, taxiway centerline marking, enhanced taxiway marking, geographical position point marking, non-movement area boundary marking, runway sidestep marking, taxiway edge marking, displaced threshold marking, runway demarcation bar marking and the like, may have different marking requirements. Measuring, locating and recording these different marking characteristics for these different markings, and taking such measurements over time intervals, produces data which can be used in different embodiments of the apparatus and methods disclosed herein.

Some of the target benefits of the system described herein are development of multiyear schedules for airfield predictive maintenance that keep an airfield's markings compliant with all FAA and ICAO requirements at a cost less than the cost of entirely repainting an airfield's runways or a runway when only a portion of the airfield's or runway's markings require replacement to keep the airfield and runway in FAA compliance, save maintenance expense, extend pavement and marking lifecycles and enhance airfield safety.

The described predictive maintenance method is intended to help determine where and when some but not all different specific areas need maintenance. It provides improved budgeting and cost savings by focusing expensive removal and repainting on critical areas that need repainting and by delaying or eliminating unnecessary and wasteful remarking portions of airfields and runways which do not need remarking. The method disclosed uses a predictive maintenance system to reduce unnecessary runway incursions and excursions by identifying, targeting, allocating and scheduling airfield markings which require improvement and delaying maintenance of airfield markings which do not currently require improvement to improve marking visibility at a lesser cost.

Intended benefits of the described system, among others, are reduction of runway incursions and excursions by enhancing airfield markings to improve visibility through specialized airfield maintenance programs. In one method, use of the system begins with making multiple sequential tests of individual portions of a runway over time, collecting the data and evaluating the airfield markings measurements including retroreflectivity, alignment, dimension, material application and overall compliance. The sequential tests of the different airport marking portions may be one month, two-month, three-month, six-month, one year, 18 months, two-year, and many years apart. The more data collected, the better the ultimate predictive scheduling for the individual runway portions will be. After this different specific location markings data is analyzed to identify critical safety issues and FAA Part 139 and ICAO discrepancies, a detailed evaluation of the recorded data is digitally formatted onto an interactive GPS platform. This resulting image shows the exact location of points for a large-scale overview of the airfield's current marking measurements, their individual rates of change, and when they will individually cease to be FAA compliant. Using the information derived from the analysis report, an accurate predictive maintenance program schedule can be developed to ensure markings remain compliant.

Typical airfield assessments include: evaluate airfield markings performance, quality and overall compliance; compile mobile retroreflectivity measuring units on all long lines and runway markings to ensure short closure times and a minimum interpreting to airport operations; analyze the airport's markings data to identify critical safety issues and FAA part 139 and ICAO discrepancies; provide data to develop various multi-year airfield marking maintenance plans; complete the inspections with short closures and minimal disruption to airfield operations.

Particular project steps are (1) Visual Inspection—Thorough examination of airfield markings to ensure FAA and ICAO compliance. Markings verified in regards to dimensions and placement according to FAA Advisory 150/1540—1L or ICAO Annex 14. (2) Retroreflectivity Testing—Retroreflectivity readings are compiled using mobile units on all long line and runway markings to ensure short closure times and minimize interruptions to airport operations. (3) Reporting—A detailed report is generated utilizing the data collected from the visual inspection and reflectivity testing. This provides an overview of the current condition of your airfield markings. (4) Planning/recommendations—By utilizing the data collected for the report, a plan is provided based on priority and critical needs. Using other airports markings which have been determined to be equivalent to a greater or lesser degree, future maintenance models for the airport are created to provide markings compliance with a cost less than the routine cost of replacing all of the airports markings on a periodic basis.

A sample report will include: (1) Visual Reporting—a visual evaluation of the current condition of the airfields markings including deficiencies, critical needs, and opportunities for improvement. (2) Retroreflectivity—Airfield markings retroreflectivity is tested to identify critical safety issues on runways, taxiways, surface signs and enhancements according to ASTM procedures with results displayed on an interactive GPS platform. (3) Video Reporting—Data including retroreflectivity levels and exact marker locations are captured in a frame by frame, real time video reporting that provides pertinent information needed to enhance airfield safety.

The method begins with the collection and evaluation of airfield markings including retroreflectivity, alignment, dimension, material application and overall compliance with applicable standards. Using specialized equipment and trained technicians, all of the markings in the movement area are inspected, assessed, and analyzed. The assessment may include an evaluation of an airfield's markings performance, quality and overall compliance with FAA (and other applicable) standards.

The data regarding the airfield markings is then analyzed in order to identify critical safety issues and FAA and International Civil Aviation Organization (“ICAO”), or other governing agency requirement discrepancies. A detailed evaluation of the recorded data is digitally formatted onto an interactive Global Positioning System (“GPS”) platform. The resulting image shows the exact location of points for a large-scale overview of the airfield. Using the information derived from the analysis report, an accurate predictive maintenance program can be developed to ensure the markings remain compliant. Additionally, lesser damaged markings that are not in need of maintenance can be placed upon a less frequent maintenance program, while more damaged markings can be placed upon a more frequent maintenance program.

It is anticipated that assessments will be completed using trained personnel doing visual assessments as well as retroreflectivity testing using a vehicle mounted mobile detection unit. Using mobile detection units on long lines and runway markings helps to ensure shorter runway closure times and minimizes interruptions to airport operations. As used herein, a “detection unit” is a device that can be any of several devices that are known in the art to determine retroreflectivity of airfield markings such as, but not limited to, handheld contact light meters or with non-contact light meters. Contact light meters require the detection unit to be in physical contact with the marking surface. Non-contact light meters, which measure the retroreflectivity from a distance, include both hand-held light meters and vehicle-based light meters that can measure retroreflectivity at specific locations while traveling at velocities above zero (0).

After inspecting, assessing and analyzing markings in the movement area, a report is prepared and delivered along with a summary of key findings. The assessment may begin with a visual evaluation of the markings followed by retroreflectivity testing using our vehicle mounted mobile unit. Typically, evaluation of the current markings relative to the FAA's requirements is delivered. Next, projections of the markings future measurements over extended time are prepared and delivered. Finally, alternate preventive maintenance alternatives are prepared and delivered. A target benefit is to reduce the cost of overall maintenance by targeting marking locations which will need to be maintained relatively sooner, thus saving the cost of maintenance of other locations that do not need to be maintained for relatively longer period of time. Thereafter, in consultation with airport management a long-term work plan is developed to prioritize maintenance needs.

### DETAILED DESCRIPTION OF THE PREFERRED EMBODIMENT

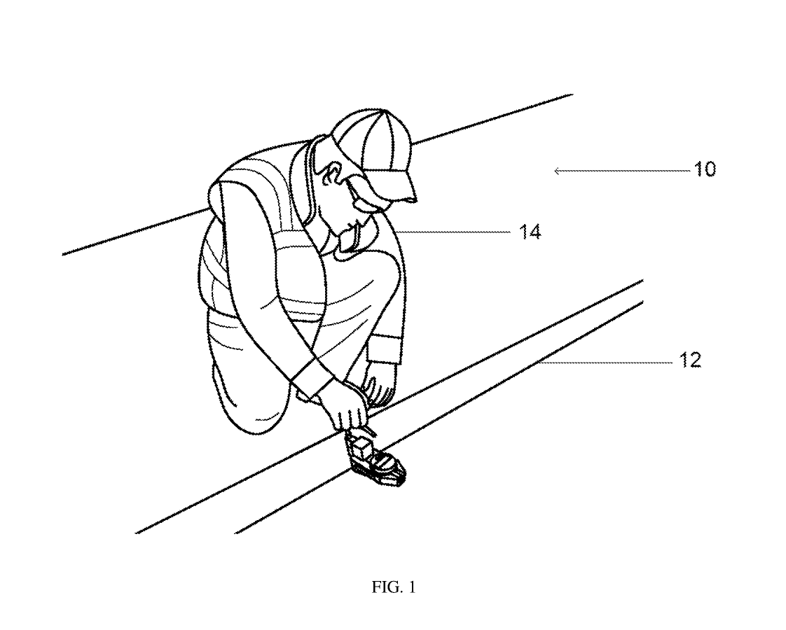

Referring to the figures, FIG. 1 illustrates a step in an embodiment of the assessment and predictive maintenance method.

FIG. 1 shows a trained technician 14 visually inspecting an airport marking 12. It is important that a thorough examination of the airfield markings 12 be completed in order to ensure FAA and ICAO compliance. Markings 12 at airfields 10 are verified in regard to their dimensions and placement and according to FAA regulations and Advisory Circulars, as well as ICAO regulations and Annexes. The data is recorded in a computer memory.

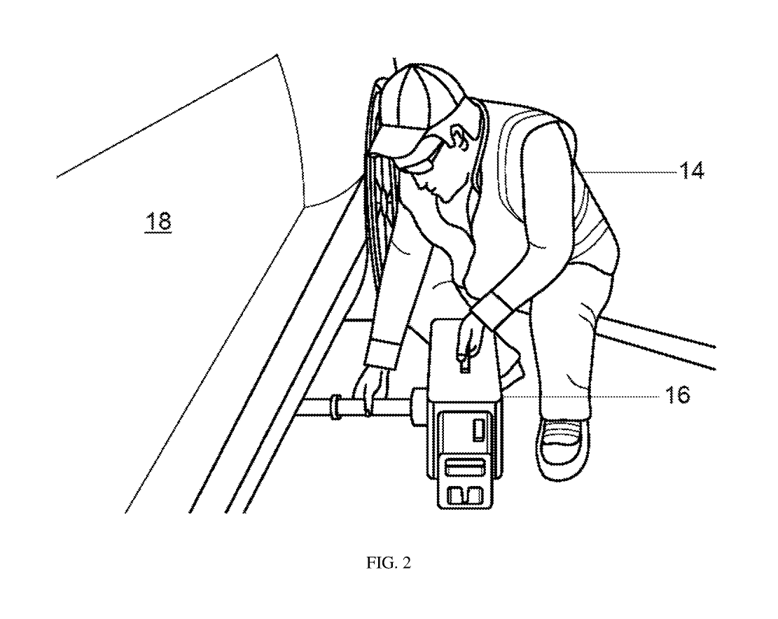

FIG. 2 shows a detection unit 16 being attached to a vehicle or mobile unit 18. The detection unit 16 is operated from a vehicle 18 so an evaluation of airport markings 12 can be accomplished in a shorter timeframe. When coupled with a GPS system, the system records markings 12 that are in compliance with applicable standards as well as those who show derivations from standard. The detection unit 16 is connected or attached generally to a low portion of the vehicle 18 such that adequate evaluations are obtained.

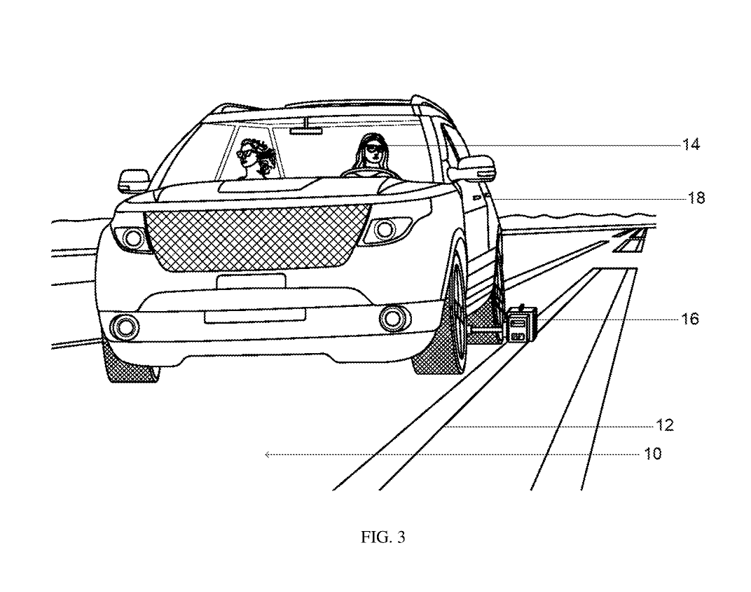

FIG. 3 shows a vehicle 18 with an attached detection unit 16, or combined a “mobile unit,” performing an assessment of the markings 12 on an airfield 10. The retroreflectivity readings are compiled by detection units 16 by a technician 14. This is particularly effective on longline and runway markings 12. The mobile units 18 are adapted to measure long-distance markings 12 and help ensure relatively shorter closure times of the airport 10 or specific runways to minimize interruptions to airport 10 operations.

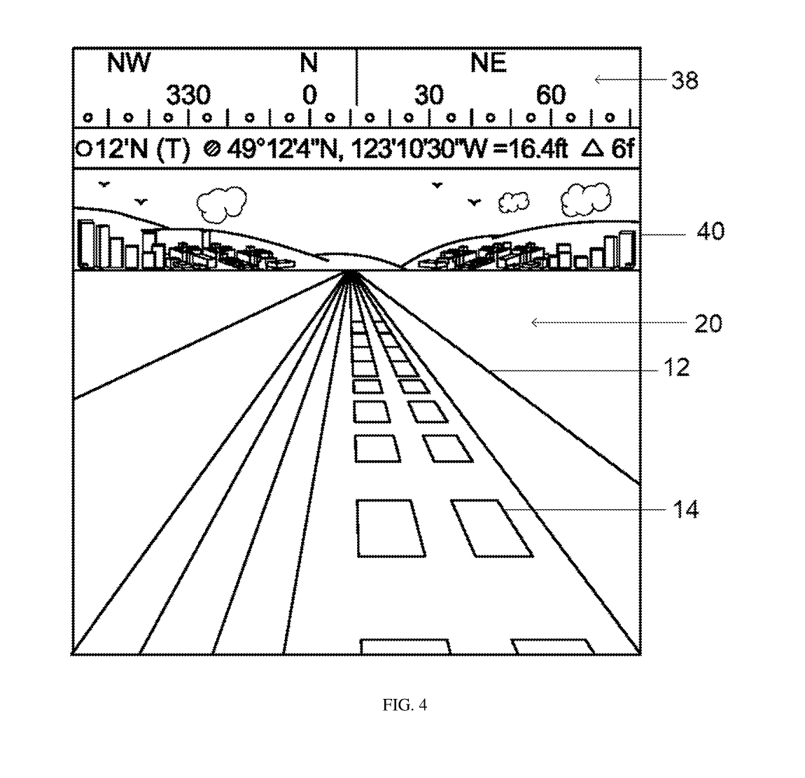

FIG. 4 illustrates a sample of a visual report of airport markings 12 for an embodiment. Visual reporting may be done by trained, qualified and experienced technicians 14 who perform a visual evaluation of the current condition of the airfield markings 12. The technician 14 may note deficiencies, critical needs, and opportunities for improvement and record it. It is anticipated that a vehicle 18 connected display 20 will provide information to the technician 14 such as an indication that the mobile unit 18 has recognized and is tracking a marking 12, directional, and positioning information. The detection unit 16, locating unit 39, and recording unit 40 make up a retroreflectivity module. The data collected is recorded in a computer memory.

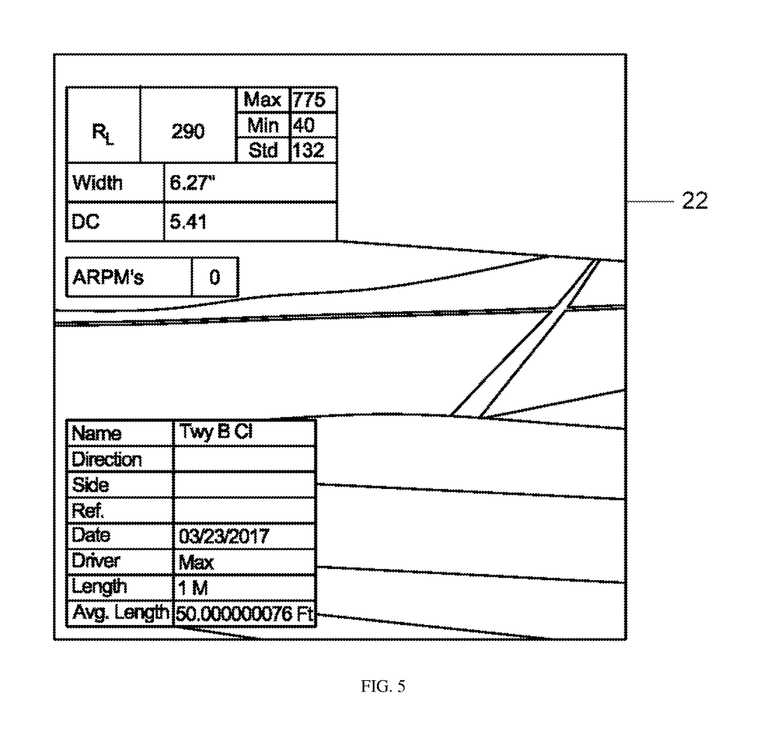

FIG. 5 illustrates a sample of a video report of airport markings 12. Video reporting 22 may include, without limitation, retroreflectivity levels and exact marker locations, which can be captured in a frame by frame, real-time video recording 22 that provides pertinent information needed to enhance airfield 10 safety.

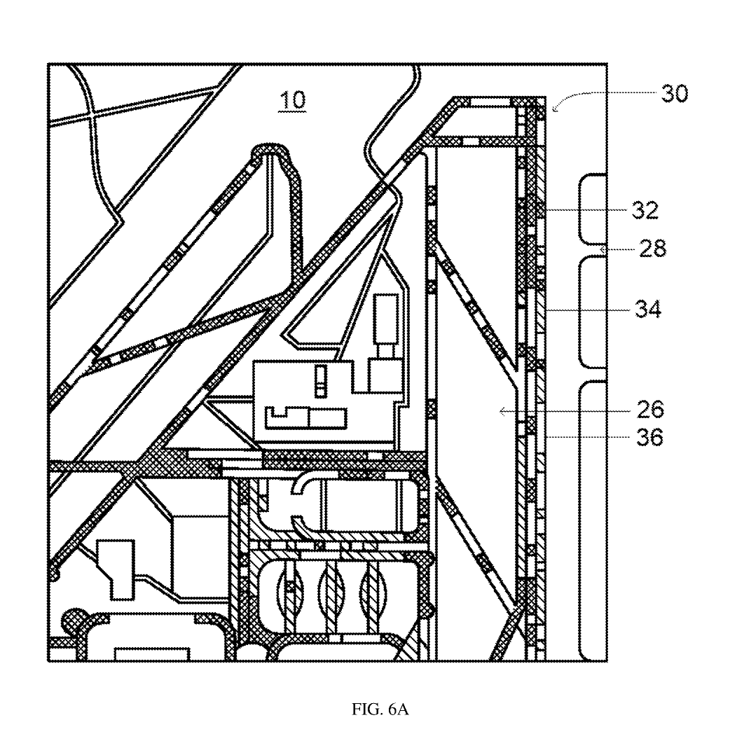

FIG. 6A illustrates a first sample of a GPS retroreflectivity map 24. The airfield markings' 12 retroreflectivity is tested to identify critical safety issues on runways 24, taxiways 26, service signs, and enhancements according to ASTM procedures. The results of such testing may be displayed on a map 24 using GPS data. The GPS map 24 of retroreflectivity readings 30 may be interactive for the user 14. Various levels of wear to the airfield markings 12 can be indicated in the retroreflectivity map 24. For example, a section of marking that is currently in need of repair 32 can be indicated, as well as sections that will need repair in the near future 34 or that are not in need of repair at the current time 36. Similarly, users 14 can find color coding of the various states (32, 34, 36) of the markings 12 to be helpful. For example, portions in immediate need of repair 32 shown in red, portions soon to be in need of repair 34 shown in yellow, and portions that are in compliance 36 show in green.

FIG. 6B illustrates a second sample of a GPS retroreflectivity map. It is anticipated that reflectivity maps of the same airport, or section of airport, can be combined over time to enable tracking areas of high wear versus lower wear. In this manner, unique maintenance plans can be developed providing for more frequent marking repair in areas of high wear and damage to the markings, and less frequent marking repair in areas of lower wear and damage. This data is used to create a schedule for removing and replacing less than all of the runway's markings in accordance with the schedule which will keep the runway in compliance with FAA standards and a lesser cost than replacing the entirety of the runway's markings whenever any portion of the runway markings cease to comply with FAA standards.

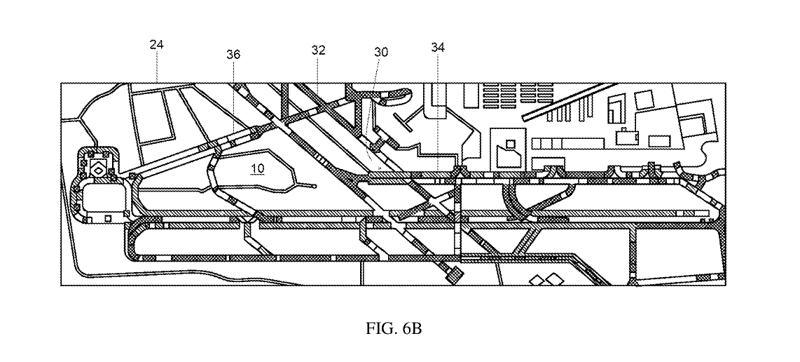

FIG. 7 shows technicians 14 gathering visual data for the airport marking 12 evaluation. A detailed report can be generated utilizing data collected from both visual inspections done by technicians combined with reflectivity testing done by detection units 16 from mobile units 18. The benefits of visual inspections combined with the benefits of reflectivity testing provide an overview of the current condition of the airfield markings 12.

The output of a maintenance model for a section of airport marking utilizes the data collected for the report from technicians 14 and mobile units 16, an airport marking maintenance plan can be generated based upon priority and critical needs. It is anticipated that software could be used to develop models for planning future maintenance to ensure markings compliance. Such a system allows the airport administration to track deteriorating markings, and help develop long-term, such as multi-year, airfield maintenance plans. Such plans, when followed, could help the airport save money, extend pavement and marking lifecycles, enhance overall airfield safety, while keeping the airfield markings in compliance with applicable standards.

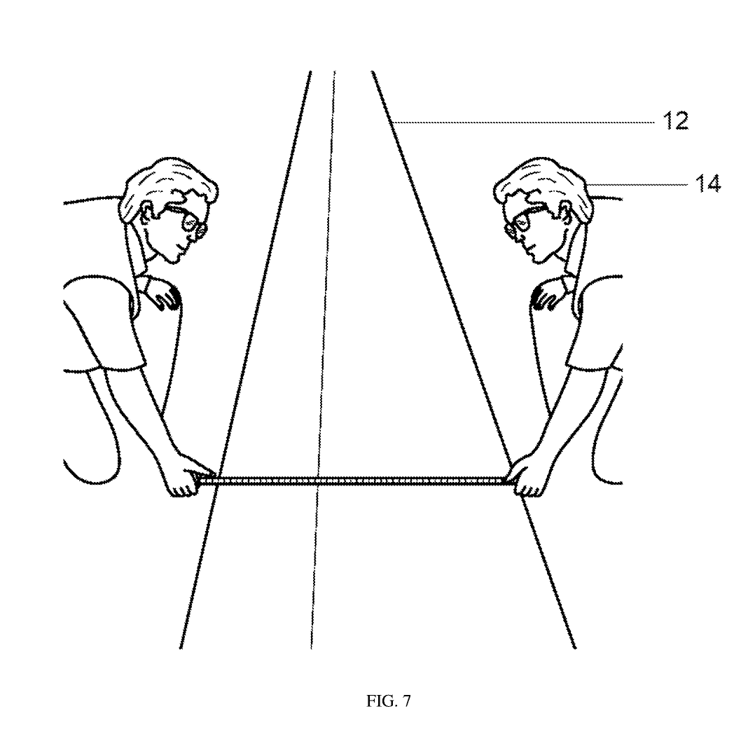

FIG. 8 is a graph showing retroreflectivity measurements taken at a runway marking location O at times T1-T4 and retroreflectivity measurements taken at a runway marking location X at the same times T1-T4, together with the FAA minimum standard for retroreflectivity at those marking locations. Currently, many airports remove and replace all markings at the airport, or all markings on particular group of runways, or a particular runway whenever any marking at the airport, group of runways or the runway needs to be removed and replaced. This is wasteful because the markings at location X can be instead removed and replaced on a longer cycle than the markings at location O. FIG. 8 shows that an extrapolation or projection can be made from the T1-T3 measurements showing that the marking at location O will need to be removed and replaced before the marking at location X will need to be removed and replaced. Such data and projections are used in scheduling repair and replacement of some, but not all, portions of the markings as those portions need to be removed and replaced.

Although the graph of FIG. 8 is directed at retroreflectivity measurements at specific marking GPS coordinates, it is analogously applicable to color, dimensions and the like. The same or other locations may be measured for color, width, friction and any other FAA or other relevant characteristics. As shown in FIG. 8, the several tests may be repeated at times T1-T4 and at intervals out to indefinite time Tn. Line fitting produces marking characteristic rate of change determinations and projections of how long the markings were remain compliant with FAA standards and not need to be removed and replaced at different particular GPS locations. These tests may be repeated at numerous GPS locations.

The graph of FIG. 8 further illustrates that after a certain number of measurements at location O and at location X, the deterioration over time of the markings at the respective locations can be projected or extrapolated. Currently, data specifically locating marking portions which may deteriorate more quickly than other marking areas is typically not organized or used for projection and preventive maintenance scheduling of removal and repair of only most urgent upcoming noncompliant portions of runway. Currently, data specifically locating marking areas with respect to retroreflectivity or other measurements is not typically used in differential or sequential maintenance marking scheduling. Currently, marking measurements and marking location data are not typically correlated over time with historical such measurements and location data, and are not typically used to project when the sum specific markings will cease to be in compliance with the FAA minimum requirements, while other specific markings at the same airport or on the same runway will continue to be in compliance.

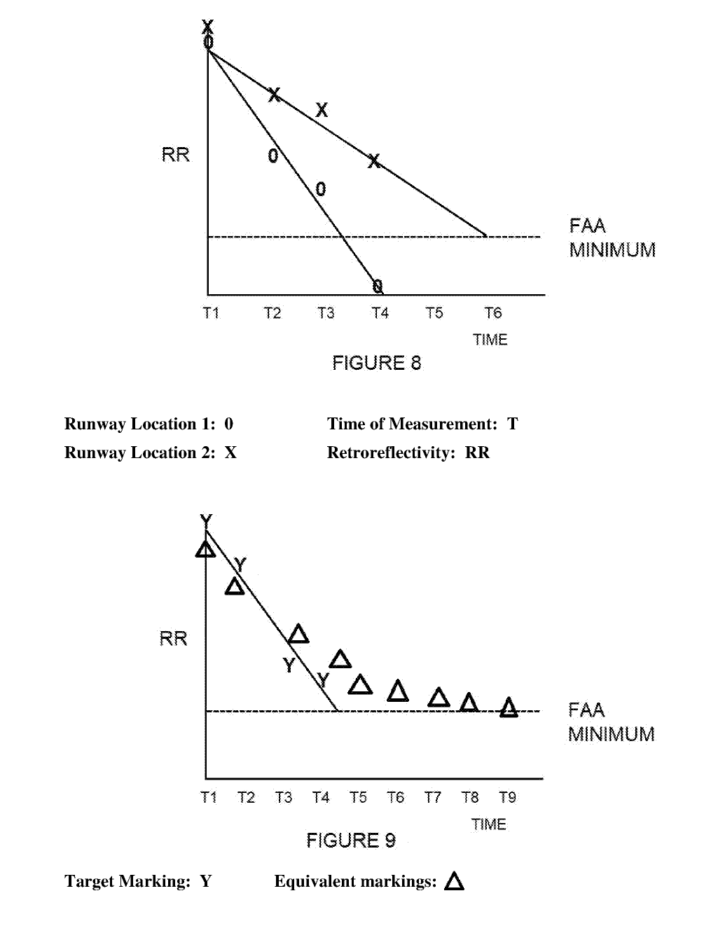

FIG. 9 is a graph illustrating that, in an embodiment, a particular measurement, such as retroreflectivity, over time T-T4 can be plotted and projected to show those runway portions which will be not compliant with FAA minimum requirements at time T5. However, the FIG. 9 graph also illustrates that for this particular type of marking at this particular type of runway location, local weather patterns, usage, pavement, paint type, bead type and quantity, etc., there are equivalent markings at equivalent airports which have equivalent characteristics, and for which retroreflectivity deterioration plateaus. In the illustrative FIG. 9 graph, the similar markings, having a similar set of historical measurement data, do not cease to be compliant with FAA minimum requirements until time T9. Thus, for this particular marking at location Y on this particular runway, a documented data driven compliance program can show that the marking at location Y does not need to be removed and replaced at T4, but, rather, will be FAA compliant until T9. Similar measurements and methods will show that other portions of that airfield runways or that runway will be FAA compliant before or after T9, and thus will need to be removed and replaced before or after T9. The applicable units of time may be a month, 2 months, 3 months, 6 months, one year, 18 months or years out until indefinite time Tn. Because the cost of closing a runway and removing and replacing markings is immense, such a predictive maintenance system may be useful.

A benefit of the described system is that it is reproducible and data driven. As a practical matter, reducing marking maintenance costs by lengthening marking maintenance cycles for certain stretches of markings on airports or runways is only possible if the FAA approves the proposed lengthening of the marking maintenance cycle for different portions of different runways. The system using data from numerous equivalent markings at equivalent runways at equivalent airports provides the robust historical numerical support needed to obtain such FAA approval. Further, the described system of visually presenting its preventive maintenance, particularly in maps and graphs, will help airport procurement officers budget maintenance and obtain FAA approvals.

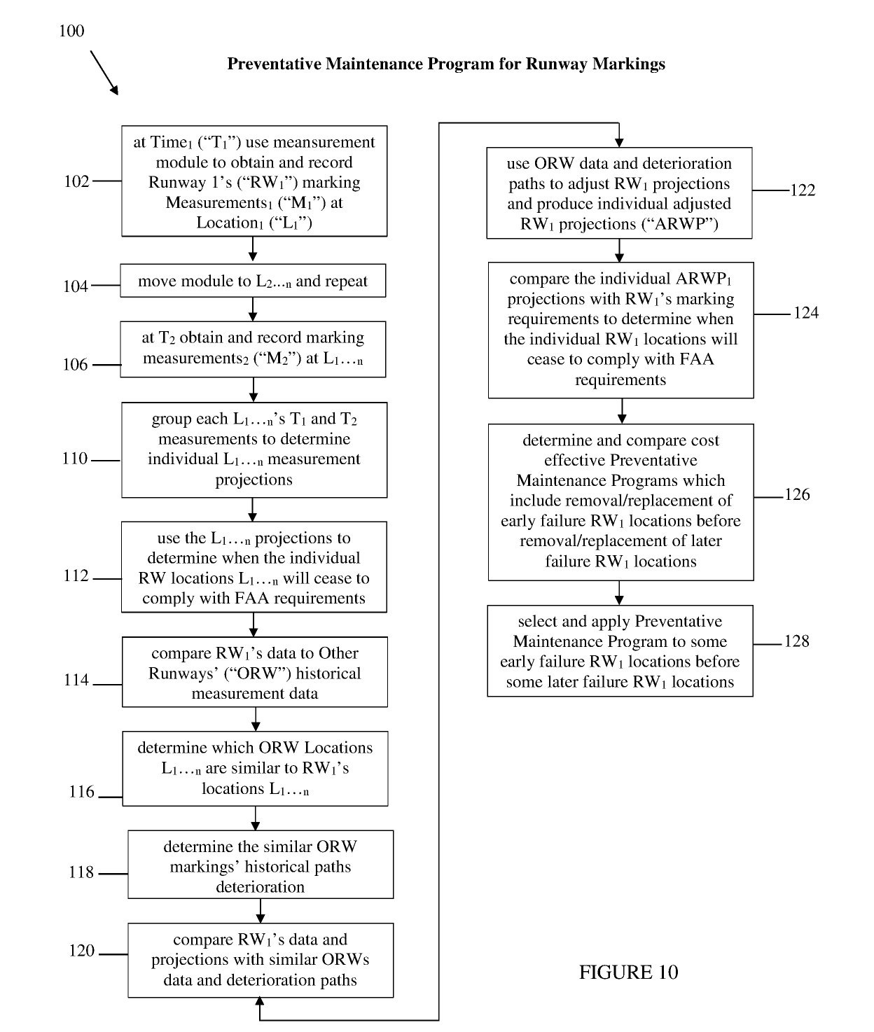

FIG. 10 shows a preventive maintenance program for runway markings flowchart 100. The first step 102 is, at a Time T-1, obtain and record the first runway's markings measurements at location L1. The next step 104 is to move the measurement module to additional locations along the marking and repeat the tests and obtain and record the measurements. The next step 106 is to return to the marking at a later time, whether a month later, 6 months later, a year later or years later and repeat the tests and obtain and record the measurements. The next step 110 is to extrapolate or plot a best fit line of the measurements over time for each of the markings locations were measurements were making. The next step 112 is to use the projections or extrapolated best fit lines in a comparison with the FAA's requirements or other requirements to determine when the markings at each separate marking location will fail to comply with the FAA's requirements or other requirements. The next step 114 is to compare the first airport runway's data and projections with other similar airport runway's historical data. The next step 116 is to determine the other runways historical deterioration paths toward and past the FAA requirements. The next step 120 is to adjust the first runway's projections to take into account the deterioration paths of the other similar runways marking measurements. This may be done by averaging, clustering, at best-fit line projection or other grouping analysis which takes advantage of the fact that deterioration of similar markings on similar airport runways are likely to have some similarities in their deterioration pathways over time when relevant factors such as use, local weather, type of aircraft etc. are factored in.

The next step 122 is to use the adjusted projections to determine when the first airport's individual runway locations will fail to continue to comply with the FAA's requirements. The next step 124 is to determine and compare cost-effective preventive maintenance programs which include removal and replacement of early failure runway markings locations before later failure runway marking locations. The next step 126 is to select an appropriate preventive maintenance program and apply it to runway locations which the described method has determined are likely to fail before other runway locations.

Applying this described method keeps the airport's runways in compliance with FAA regulations at a substantially reduced cost relative to the cost of removing and replacing all of the airports runways or the runway whenever any portion of the airports runways or the runway ceases to be in compliance with FAA standards.

In an embodiment, the detection unit records individual data points and the individual data points are identified on a GPS overlay to include retroreflectivity, latitude and longitude locate location. The runway markings are correlated and mapped with feature runway areas such as taxiing area, landing area, turn area etc. Photographs capture images of the Estep segments units location relative to the runway to identify per sash measurements and condition of runway markings. The captured runway marking data points, past and present, are correlated with past and present data points of similar portions of similar runways to produce runway marking measurement projections which incorporate historical relationships at other similar runways and featured areas. An algorithm for predictive modeling based on the features and characteristics project and extrapolate with required runway marking requirements to produce projected time periods for required repair and maintenance of runway markings, which projections are unique for different runway zones appropriate for maintenance and repair. Work plans are developed from the measurements, correlated measurements and relationship based extrapolations that identify and prioritize maintenance needs based on the assessment measurements to create optimal beneficial impact work plans, cost estimates and projections for runway marking maintenance activities.

After an assessment, a report can be prepared and delivered to the user regarding key findings and proposed maintenance schedules. The report includes long-term work plans developed to prioritize maintenance needs. The data may be compiled using mobile retroreflectivity measuring units on all longline and runway markings to ensure short closure times and minimize interruptions to airport operations.

In an embodiment, keeping a runway's markings compliant with airfield runway and taxiway marking retroreflectivity requirements is accomplished by a technician using a retroreflectivity module. “Retroreflectivity” refers to the property of an airfield marking to reflect light back to a pilot or aircraft operator. Retroreflective markings are used to increase the markings' visibility—particularly at night. Maintaining marking retroreflectivity is important for airfield safety. The retroreflectivity module is made up of a detection unit for measuring retroreflectivity of runway markings, a location unit for identifying the position of measured runway markings, and a recording unit for recording the retroreflectivity measurements and the position measurements. As used herein, a “location unit” can be any of devices or methods that are known in the art to determine location such as, but not limited to, a GPS unit, cellular signals, Wi-Fi geolocation, Spot-Fi, and Geolocation API.

Numerous characteristics of a marking are measured and recorded when testing an airfield's markings. The quantity and types of deeds in a paint stripe produce different radiographic signatures. The width of airport runway markings are many times larger than most markings on most highways, making most highway marking recording devices inappropriate. Airport runway hold bars are tens of feet wide. The color of each marking is recorded on the color spectrum. The width of a marking's paint may vary from the width of the markings reflected beads. The thickness and other significant characteristics of the marking are checked by the FAA. These two widths must be recorded separately. Each of the FAA's many requirements for airport markings must be measured, located on the runway, correlated with the location, recorded, compared with past and future recordings of that airport markings measurement of that marking characteristic at that location, compared with past and future recordings of other equivalent airport markings measurements of that marking characteristic at equivalent locations, and the results projected and extrapolated to produce a predictive maintenance program with that particular marking at that location in the context of the airport's marking removal and replacement requirements generally. These measurements are collected and used in different statistical analyses to quantify a predictive maintenance program which will cost less to sufficiently maintain compliance with FAA requirements.

At a first time, or Time α, the technician drives a vehicle with the mounted detection unit along the runway using the retroreflectivity module to sequentially record multiple individual retroreflectivity measurements from paint markings on an airport runway and individual runway position measurements. The readings are recorded at a multiplicity of specified positions. The position of the detection unit is also noted at each individual retroreflectivity measurement. For Time α, the multiple individual retroreflectivity measurements and their corresponding multiple runway position measurements are paired at location a. As used herein when referring to corresponding marking and position measurements, “corresponding” means measurements taken at approximately the same location. Thus, a record for Time α is created, correlating the runway's markings' retroreflectivity measurements, or α retroreflectivity measurement, with each retroreflectivity measurement's runway position measurement, or α location. The pairing and storing of the Time α digital record of the correlated runway's markings' retroreflectivity measurements and their runway position measurements may be done in a general-purpose or special-purpose computer. The runway's Time α correlated markings' retroreflectivity measurements are compared with FAA or similar airport runway marking retroreflectivity requirements, where it can then be determined which, if any, of the runway's Time α markings' retroreflectivity measurements indicate runway markings which require greater retroreflectivity to be compliant with the FAA or similar airport runway marking retroreflectivity requirements.

At a later date, or Time β, anticipated to be at least six months after Time α, a technician again moves a retroreflectivity module along the runway (or taxiway). As the retroreflectivity module moves along the runway (or taxiway), it is again used to sequentially record multiple individual retroreflectivity measurements, or β retroreflectivity measurements, from paint markings along the airport runway or taxiway along with corresponding individual position measurements, or β locations, so the position of each retroreflectivity measurement is known. Because the positions from all of the retroreflectivity measurements from both Time α and Time β are known, individual retroreflectivity measurements at specific locations for both Time α and Time β are paired with their corresponding multiple Time α individual runway position measurements. Effectively, there is an α retroreflectivity measurement and a β retroreflectivity measurement taken at each location α. It is anticipated that this can be done on a general-purpose or special-purpose computer, creating a digital record of multiple Time β correlated runway's markings' retroreflectivity measurements and their Time β runway position measurements. The runway's Time β correlated markings' retroreflectivity measurements can be compared with FAA or similar airport runway marking retroreflectivity requirements to determine if any of the markings require retroreflectivity to be added at certain positions.

The Time α and Time β records of the correlated runway's markings' retroreflectivity measurements and their runway position measurements are compared and paired so records from Time α of the location α retroreflectivity measurements and their corresponding location a positions and from Time β of the location β retroreflectivity measurements and their corresponding α positions (records are paired by location, so pairings are where the α positions are the same or about the same as the location β positions). The changes in the retroreflectivity measurements from Time α to Time β at the various α positions can be used to help determine the amount of degradation, if any, of the runway's markings has occurred in the past and is likely to occur in the future. It is anticipated that retroreflectivity measurements will be taken at positions at intervals over the entire airfield. The amount of time between Time α and Time β and the amount of degradation of the markings at a given position can be used to determine a degradation to time relationship. The degradation to time relationship can be used to determine which locations of the markings are degrading faster, and thus are more likely to need greater retroreflectivity to be compliant with the FAA or similar airport runway marking retroreflectivity requirements in the future and how long into the future. Or, the relationships between the Time α correlated markings' retroreflectivity measurements with the Time β correlated markings' retroreflectivity measurements and the temporal difference between Time α and Time β, are used to determine the runway's markings' retroreflectivity degradation to time relationship. The runway's markings' retroreflectivity degradation to time relationship is used to predict how long the runway's markings' retroreflectivity will be compliant with the FAA or similar airport runway marking retroreflectivity requirements.

It is also anticipated that handheld detection units and location units can be used to acquire retroreflectivity measurements and locations in order to supplement retroreflectivity modules (which are comprised of a detection unit for measuring retroreflectivity of the marking, a location unit for identifying the location of the measured runway marking, and a recording unit for recording the retroreflectivity measurement and the runway position measurement). The measurement modules may be located on a mobile platform, such as a vehicle, drone, wheeled or slidable wagon, a handheld unit or other platform which can hold the measurement modules and be moved along pavement markings.

While the vehicle mounted retroreflectivity modules are efficient for long line markings, hand-held modules may be more efficient for use on short markings and indicators such as numbers or letters. Thus, the method herein anticipates using one or both of handheld and vehicle mounted retroreflectivity modules.

Predictions of how long specific positions of the runway's individual markings' retroreflectivity will be compliant with the FAA or similar airport runway marking retroreflectivity requirements can be used to create a markings retroreflectivity maintenance program which identifies first individual portions of the runway markings which will require retroreflectivity maintenance within a given time period (such as a year) to be compliant with FAA or similar airport runway marking retroreflectivity requirements. The predictions can further identify second individual portions of the runway markings which are predicted to not require retroreflectivity maintenance within that same time period.

Airfields similar to the subject airfield for which a maintenance program is being prepared can be identified. Markings which are similar to the markings evaluated at airfields which are similar to the subject airfield can be identified. It is anticipated that the retroreflectivity maintenance program of similar airfields and similar markings may be used to predict future maintenance for the other similar airfields and similar markings. Similarity can include size, local weather, proximity to geographical features that can affect markings, amount of air traffic, types of aircraft that use the airfield, type of runway, location on the runway, type of use, type of pavement, type of paint, type of maintenance etc. Similar markings could be determined by their type, location on the airfield, amount of traffic, and types of aircraft that contact the markings.

Another use of the prediction maintenance program of how long the runway's individual markings' retroreflectivity will be compliant with the FAA or similar airport runway marking retroreflectivity requirements is to create a long range (or multi-time period, or multi-year) runway marking retroreflectivity maintenance program.

A method to keep a marking on a runway compliant with an airfield's runway marking retroreflectivity requirements is by creating a map of the airfield with indicators at the multiple a positions on the map illustrating whether or not the marking at each individual α position requires greater retroreflectivity to be compliant with the airfield's runway marking retroreflectivity requirement. To make the map more useful for users, the indicators may be color coded. For example, green for positions that do not need greater retroreflectivity to be compliant, yellow for areas that are predicted to need greater retroreflectivity to be compliant within a given time period, such as six months or a year, and red for locations that currently need greater retroreflectivity to be compliant.

It is anticipated that in order to fully integrate the data recovered by the collection and testing, software would be used to evaluate such data recorded on a specific airfield. Additionally, other factors unique to the specific airfield can be incorporated using constants consistent among airfields to help evaluate the airfield. In order to develop a predictive maintenance plan, software could be used that directs data collection as well as evaluate it. However, whether software is used or not, a system of temporally evaluating the data in order to generate predictive maintenance plans could be effected. Such predictive maintenance plans allow the airport's administration to know when and where specific areas of the airport markings need maintenance. This allows for improved budgeting and significant cost savings by focusing maintenance on areas of the airfield markings with critical needs while eliminating unnecessary and wasteful remarking of the entire airfield.

Statements concerning the described apparatus and method are sometimes made in the present tense. Use of the present tense is for simplicity, however, as some of the apparatus, methods, steps and results are anticipated apparatus, methods, steps and results rather than statements of past tests and use.

The terms “about” or “approximately” are defined as being “close to” as understood by one of ordinary skill in the art, and in one non-limiting embodiment, the terms are defined to be within 10%, preferably within 5%, more preferably within 1%, and most preferably within 0.5%. Accordingly, unless indicated to the contrary, the numerical parameters set forth in this specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

The term “substantially” and its variations are defined as being largely but not necessarily wholly what is specified as understood by one of ordinary skill in the art, and in one non-limiting embodiment, substantially refers to ranges within 10%, within 5%, within 1%, or within 0.5%.

The term “effective,” as that term is used in the specification and/or claims, means adequate to accomplish a desired, expected, or intended result.

The terms “a” or “an” when used in conjunction with the term “comprising” in the claims and/or the specification may mean “one,” but it is also consistent with the meaning of “one or more,” “at least one,” and “one or more than one.”

The term “each” refers to each member of a set or each member of a subset of a set.

The terms “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

In interpreting the claims appended hereto, it is not intended that any of the appended claims or claim elements invoke 35 U.S.C. 112(f) unless the words “means for” or “step for” are explicitly used in the particular claim.

It should be understood that, although exemplary embodiments are illustrated in the figures and description, the principles of the present disclosure may be implemented using any number of techniques, whether currently known or not. The present disclosure should in no way be limited to the exemplary implementations and techniques illustrated in the drawings and description herein. Thus, although the invention has been described with reference to specific embodiments, this description is not meant to be construed in a limited sense. Various embodiments may include some, none, or all of the enumerated advantages. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention. Modifications, additions, or omissions may be made to the systems, apparatuses, and methods described herein without departing from the scope of the disclosure. For example, the operations of the systems and apparatuses disclosed herein may be performed by more, fewer, or other components in the methods described may include more, fewer, or other steps. Additionally, steps may be performed in any suitable order.

A method of determining a runway markings' future compliance with predetermined airfield runway marking requirements, comprising: providing a retroreflectivity module comprising: a detection module for measuring retroreflectivity of the markings, a location module for identifying the location of measured runway markings; attaching the retroreflectivity module and location module to a mobile platform; providing a recording module for recording the retroreflectivity measurements and the measurement locations; moving the mobile platform along the marking at a Time α and, as the attached retroreflectivity module moves along the marking, using the retroreflectivity module to record a Time α retroreflectivity measurement from the marking and using the location module to record the marking's α location; creating a record of the α retroreflectivity measurement and its corresponding α location; determining whether the Time α retroreflectivity measurement indicates that the marking at the α location requires greater retroreflectivity to be compliant with the airfield's runway marking retroreflectivity requirement by comparing the runway's Time α retroreflectivity measurement with the airfield's runway marking retroreflectivity requirement for the α location; moving the mobile platform along the marking at a Time β, which is after Time α, and, as the retroreflectivity module moves along the marking, using the retroreflectivity module to record a Time β retroreflectivity measurement from the marking and using the location module to record the marking's α location; creating a record of the β retroreflectivity measurement and its corresponding α location; determining whether the Time β retroreflectivity measurement indicates that the marking at the α location requires greater retroreflectivity to be compliant with the airfield's runway marking retroreflectivity requirement by comparing the runway's Time α retroreflectivity measurement with the airfield's runway marking retroreflectivity requirement for the α location; and using the Time α retroreflectivity measurement at the α location and the Time β retroreflectivity measurement at the α location, and the temporal difference between Time α and Time β to determine an initial projection for when the marking's retroreflectivity at the α location will become noncompliant with the airfield's runway marking retroreflectivity requirement at the α location.

The method of claim 1, further comprising: conducting the steps of claim 1 at other runway markings at other airfields prior to conducting the steps of claim 1 at the airfield of claim 1; determining which of the other runway markings at the other airfields are most similar to the runway marking at the α location of the claim 1 airfield runway and have both early retroreflectivity measurements which indicate higher retroreflectivity than the Time β retroreflectivity measurement runway marking at the α location of the claim 1 airfield runway and which also have later retroreflectivity measurements which indicate lower retroreflectivity than the Time β retroreflectivity measurement runway marking at the α location of the claim 1 airfield runway; determining a marking at a θ location at a similar airfield runway which marking at a the θ location is similar to the marking at the α location at the airfield runway of claim 1; and using the other similar airfields' runway's marking retroreflectivity deterioration path at the θ location to adjust the initial projection for how long the marking at the α location at said airfield runway of claim 1 will be compliant with the claim 1's airfield's runway marking retroreflectivity requirement, the adjustment moving the initial projection closer to the similar airfields' deterioration path.

The method of claim 1, further comprising: repeating the steps of claim 1 at additional multiple different individual locations along the runway, wherein each individual location is a different α location; using the initial projections of how long the marking's retroreflectivity at each individual location will be compliant with the airfield's runway marking's retroreflectivity requirement to determine different possible marking maintenance programs for repairing and replacing individual markings portions which will cease being compliant with the airfields marking requirements prior to preparing and replacing the entirety of the runway's markings, including using the initial projections to determine the cost of the different possible marking maintenance programs, and selecting a marking maintenance program which is less expensive than repairing and replacing the entire runway's marking when a first portion of the entire runway's marking ceases to comply with runway marking requirements; and creating a markings maintenance program which identifies first runway markings portions which the initial projections show will require retroreflectivity maintenance to be compliant with the airfield runway markings retroreflectivity requirements before other portions and identifies second runway markings portions which the initial projections show will not require retroreflectivity maintenance until after other portions and schedules repair and replacement of the first runway markings portions before repair and replacement of the second runway markings portions.

The method of claim 1, wherein the period of time between Time α and Time β is at least 6 months.

The method of claim 1, wherein the period of time between Time α and Time β is at least one year.

The method of claim 3, further comprising using the prediction of how long the marking's retroreflectivity at each individual location will be compliant with the airfield runway marking retroreflectivity requirement to create a multi-year maintenance program which identifies when each of the individual locations of the runway markings are predicted to require retroreflectivity maintenance to be compliant with the airfield runway marking retroreflectivity requirement.

A method of creating a geographic map showing compliance with airfield runway marking requirements, comprising: providing a measurement module comprising: a detection module for measuring characteristics of the marking, α location module for identifying the location of the measured runway marking, and a recording module for recording the measured characteristics and locations; connecting the measurement module to a mobile platform; moving the mobile platform along the runway and, as the measurement module moves along the runway at a Time α, using the measurement module to record characteristics of the marking and using the location module to record the marking's α location; creating a record of the α markings characteristics at the α location; comparing the marking's recorded characteristics at α location with the airfield runway marking requirements at α location; determining whether the α retroreflectivity measurement indicates that the marking at the α location is compliant with the airfield runway marking requirements at α location; and; creating an airfield runway requirements compliance map with an indicator at the α location on the map illustrating whether the marking at the α location is compliant with the airfield runway's requirements.

The method of claim 7, wherein the indicator is color coded.

The method of claim 7, wherein marking characteristics recorded and compared for compliance comprise retroreflectivity, width and continuity, and each of these characteristics is indicated on the compliance map.

A method of determining when different portions of a first airport runway's markings will be cease being compliant with predetermined airport runway marking requirements, comprising: providing a mobile platform for moving above an airport runway marking; providing measurement modules comprising a retroreflectivity module for measuring marking retroreflectivity, a width module for measuring marking width, a location module for identifying the measured marking location, and a recording module for recording the retroreflectivity, width and location measurements; connecting the measurement modules to the mobile platform; moving the mobile platform along the marking at a Location 1 (“L1”) at a Time 1 (“T1”) and, as the mobile platform moves over the marking at L1, using the retroreflectivity module to measure the marking's retroreflectivity, using the width module to measure the marking's width and using the location module to locate the marking's location; creating a record of the T1 marking's measurements at location L1 in a general-purpose or special-purpose computer; storing the record of the T1 markings measurements and location L1 in a memory unit; determining which, if any, of the L1 at T1 marking's measurements indicate markings which require different retroreflectivity or width to be compliant with the runway's location L1 marking requirements by comparing the L1 at T1 marking's measurements with location L1's marking requirements; moving the mobile platform along the runway marking at the location L1 at a Time 2 (“T2”), which is after T1, and, as the mobile platform moves over the marking at L1, using the retroreflectivity module to measure the marking's retroreflectivity, using the width module to measure the marking's width and using the location module to locate the marking's location; creating a record of the T2 marking measurements and location in a general-purpose or special-purpose computer; storing the record of the T2 markings' measurements and location L1 in the memory unit; determining which, if any, of the L1 at T2 marking's measurements indicate markings which require different retroreflectivity or width to be compliant with the runway's location L1 marking requirements by comparing the L1 at T2 marking's measurements with location L1 ‘s marking requirements; comparing the L1 at T1 markings’ measurements and the L1 at T2 markings' measurements to determine differences, if any, between the L1 at T1 markings' measurements and the L1 at T2 markings' measurements, and determining the temporal difference between T1 and T2, and using the measurement differences and the temporal difference to determine absolute measurement changes from T1 to T2 and the rates of measurement changes from T1 to T2; using the measurements and the rates of measurement changes to project when the runway's markings' measurements at L1 will be cease being compliant with the L1's marking requirements; and scheduling removal and replacement of the L1 marking for before the L1 marking ceases to be compliant with the L1's marking requirements.

The method of claim 10 further comprising: repeating the steps of claim 10 at runway marking locations 2 . . . n (L2 . . . n); for at least some individual multiple separate marking locations L2 . . . n, project when the locations will cease being compliant with the runway's marking requirements at those locations; using the separate marking compliance projections to identify first runway marking portions which will require maintenance to be compliant with the airfield runway marking requirements before other second runway marking portions; and scheduling removal and replacement of the first runway marking portions before removal and replacement of the second runway markings portions.

The method of claim 10, wherein the runway marking requirements are FAA marking requirements.

The method of claim 10 wherein the period of time between T1 to T2 is at least 6 months.

The method of claim 10 wherein the period of time between T1 to T2 is at least one year.

The method of claim 10 wherein the period of time between the scheduled removal and replacement of the first runway markings portions and the scheduled repair and replacement of the second runway markings portions is at least 6 months.

The method of claim 12 wherein the period of time between the scheduled repair and replacement of the first runway markings portions and the scheduled repair and replacement of the second runway markings portions is at least one year.

The method of claim 12 further comprising: repeating the steps of claim 11 at multiple other airports' runways markings; collecting the other airports' runways markings and the first airport's runway marking measurements in a general or special-purpose computer; comparing the other airports' runways actual marking measurements with the first airport's markings measurements and projections; grouping similar other runways' markings measurements and the first airport's runways runway marking measurements and using the similar actual runway marking measurements to adjust the first airport's markings projections toward the other similar actual runway's markings measurements; using the adjusted first airport marking projections to identify first airport runway marking portions which will require maintenance to be compliant with the first airfield's runway marking requirements before other second runway marking portions; and scheduling removal and replacement of the first runway marking portions before removal and replacement of the second runway markings portions.

The method of claim 12 further comprising setting minimum compliance thresholds for different types of measurements, and producing a report signaling the location of markings whose measurements are less than the threshold measurements.

An apparatus for determining when different portions of a first airport runway's markings will be cease being compliant with predetermined airport runway marking requirements, comprising: a mobile platform for moving above an airport runway marking; measurement modules comprising a retroreflectivity module for measuring marking retroreflectivity, a width module for measuring marking width, a location module for identifying the measured marking location, and a recording module for recording the retroreflectivity, width and location measurements, the measurement modules being connected to the mobile platform; a guidance module capable of using the runway marking to guide the mobile platform along the runway marking, the guidance module being attached to the mobile platform; a visual image module capable of taking visual images of runway markings; a general-purpose or special-purpose computer for creating a record of the T1 marking's measurements at location L1; a memory unit for storing the record of the T1 markings measurements and visual images and location L1; the computer being capable of determining which, if any, of the L1 at T1 marking's measurements indicate markings which require different retroreflectivity or width to be compliant with the runway's location L1 marking requirements by comparing the L1 at T1 marking's measurements with location L1's marking requirements; the computer being capable of recording T2 marking measurements at the location L1 at a Time 2 (“T2”), which is after T1, creating a record of the T2 marking measurements; the memory unit being capable of storing the record of the T2 markings' measurements and visual images and location L1; the computer capable of determining which, if any, of the L1 at T2 marking's measurements indicate markings which require different retroreflectivity or width to be compliant with the runway's location L1 marking requirements by comparing the L1 at T2 marking's measurements with location L1 ‘s marking requirements, comparing the L1 at T1 markings’ measurements and the L1 at T2 markings' measurements to determine differences, if any, between the L1 at T1 markings' measurements and the L1 at T2 markings' measurements, and determining the temporal difference between T1 and T2, and using the measurement differences and the temporal difference to determine absolute measurement changes from T1 to T2 and the rates of measurement changes from T1 to T2, using the measurements and the rates of measurement changes to project when the runway's markings' measurements at L1 will be cease being compliant with the L1's marking requirements; and scheduling removal and replacement of the L1 marking for before the L1 marking ceases to be compliant with the L1's marking requirements; and a visual display capable of visually displaying at least some of the different runway markings measurements and when at least some of the different projected times at which at least some of the different runway marking locations L1 . . . n will cease being compliant with the runway marking requirements, and capable of visually displaying captured visual images of individual different runway marking locations L1 . . . n together with the individual runway marking locations L1 . . . n measurements.

I claim:

1. A method of determining a runway markings' future compliance with predetermined airfield runway marking requirements, comprising:
providing a retroreflectivity module comprising: a detection module for measuring retroreflectivity of the markings, a location module for identifying the location of measured runway markings;
attaching the retroreflectivity module and location module to a mobile platform;
providing a recording module for recording the retroreflectivity measurements and the measurement locations;
moving the mobile platform along the marking at a Time α and, as the attached retroreflectivity module moves along the marking, using the retroreflectivity module to record a Time α retroreflectivity measurement from the marking and using the location module to record the marking's α location;
creating a record of the α retroreflectivity measurement and its corresponding α location;
determining whether the Time α retroreflectivity measurement indicates that the marking at the α location requires greater retroreflectivity to be compliant with the airfield's runway marking retroreflectivity requirement by comparing the runway's Time α retroreflectivity measurement with the airfield's runway marking retroreflectivity requirement for the α location;
moving the mobile platform along the marking at a Time β, which is after Time α, and, as the retroreflectivity module moves along the marking, using the retroreflectivity module to record a Time β retroreflectivity measurement from the marking and using the location module to record the marking's α location;
creating a record of the β retroreflectivity measurement and its corresponding α location;
determining whether the Time β retroreflectivity measurement indicates that the marking at the α location requires greater retroreflectivity to be compliant with the airfield's runway marking retroreflectivity requirement by comparing the runway's Time α retroreflectivity measurement with the airfield's runway marking retroreflectivity requirement for the α location; and
using the Time α retroreflectivity measurement at the α location and the Time β retroreflectivity measurement at the α location, and the temporal difference between Time α and Time β to determine an initial projection for when the marking's retroreflectivity at the α location will become noncompliant with the airfield's runway marking retroreflectivity requirement at the α location.

2. The method of claim 1, further comprising:
conducting the steps of claim 1 at other runway markings at other airfields prior to conducting the steps of claim 1 at the airfield of claim 1
determining which of the other runway markings at the other airfields are most similar to the runway marking at the α location of the claim 1 airfield runway and have both early retroreflectivity measurements which indicate higher retroreflectivity than the Time β retroreflectivity measurement runway marking at the α location of the claim 1 airfield runway and which also have later retroreflectivity measurements which indicate lower retroreflectivity than the Time β retroreflectivity measurement runway marking at the α location of the claim 1 airfield runway;
determining a marking at a θ location at a similar airfield runway which marking at a the θ location is similar to the marking at the α location at the airfield runway of claim 1; and
using the other similar airfields' runway's marking retroreflectivity deterioration path at the θ location to adjust the initial projection for how long the marking at the α location at said airfield runway of claim 1 will be compliant with the claim 1's airfield's runway marking retroreflectivity requirement, the adjustment moving the initial projection closer to the similar airfields' deterioration path.

3. The method of claim 2, further comprising:
repeating the steps of claim 1 at additional multiple different individual locations along the runway, wherein each individual location is a different α location;
using the initial projections of how long the marking's retroreflectivity at each individual location will be compliant with the airfield's runway marking's retroreflectivity requirement to determine different possible marking maintenance programs for repairing and replacing individual markings portions which will cease being compliant with the airfields marking requirements prior to preparing and replacing the entirety of the runway's markings, including using the initial projections to determine the cost of the different possible marking maintenance programs, and selecting a marking maintenance program which is less expensive than repairing and replacing the entire runway's marking when a first portion of the entire runway's marking ceases to comply with runway marking requirements; and
creating a markings maintenance program which identifies first runway markings portions which the initial projections show will require retroreflectivity maintenance to be compliant with the airfield runway markings retroreflectivity requirements before other portions and identifies second runway markings portions which the initial projections show will not require retroreflectivity maintenance until after other portions and schedules repair and replacement of the first runway markings portions before repair and replacement of the second runway markings portions.

4. The method of claim 1, wherein the period of time between Time α and Time β is at least 6 months.

5. The method of claim 1, wherein the period of time between Time α and Time β is at least one year.

6. The method of claim 3, further comprising using the prediction of how long the marking's retroreflectivity at each individual location will be compliant with the airfield runway marking retroreflectivity requirement to create a multi-year maintenance program which identifies when each of the individual locations of the runway markings are predicted to require retroreflectivity maintenance to be compliant with the airfield runway marking retroreflectivity requirement.

7. A method of creating a geographic map showing compliance with airfield runway marking requirements, comprising:
providing a measurement module comprising: a detection module for measuring characteristics of the marking, a location module for identifying the location of the measured runway marking, and a recording module for recording the measured characteristics and locations;
connecting the measurement module to a mobile platform;
moving the mobile platform along the runway and, as the measurement module moves along the runway at a Time α, using the measurement module to record characteristics of the marking and using the location module to record the marking's α location;
creating a record of the α markings characteristics at the α location;
comparing the marking's recorded characteristics at α location with the airfield runway marking requirements at α location;
determining whether the α retroreflectivity measurement indicates that the marking at the α location is compliant with the airfield runway marking requirements at α location; and
creating an airfield runway requirements compliance map with an indicator at the α location on the map illustrating whether the marking at the α location is compliant with the airfield runway's requirements.

8. The method of claim 7, wherein the indicator is color coded.

9. The method of claim 7, wherein marking characteristics recorded and compared for compliance comprise retroreflectivity, width and continuity, and each of these characteristics is indicated on the compliance map.

10. A method of determining when different portions of a first airport runway's markings will be cease being compliant with predetermined airport runway marking requirements, comprising:
providing a mobile platform for moving above an airport runway marking;
providing measurement modules comprising a retroreflectivity module for measuring marking retroreflectivity, a width module for measuring marking width, a location module for identifying the measured marking location, and a recording module for recording the retroreflectivity, width and location measurements;
connecting the measurement modules to the mobile platform;
moving the mobile platform along the marking at a Location 1 (“L1”) at a Time 1 (“T1”) and, as the mobile platform moves over the marking at L1, using the retroreflectivity module to measure the marking's retroreflectivity, using the width module to measure the marking's width and using the location module to locate the marking's location;
creating a record of the T1 marking's measurements at location L1 in a general-purpose or special-purpose computer;
storing the record of the T1 markings measurements and location L1 in a memory unit;
determining which, if any, of the L1 at T1 marking's measurements indicate markings which require different retroreflectivity or width to be compliant with the runway's location L1 marking requirements by comparing the L1 at T1 marking's measurements with location L1's marking requirements;
moving the mobile platform along the runway marking at the location L1 at a Time 2 (“T2”), which is after T1, and, as the mobile platform moves over the marking at L1, using the retroreflectivity module to measure the marking's retroreflectivity, using the width module to measure the marking's width and using the location module to locate the marking's location;
creating a record of the T2 marking measurements and location in a general-purpose or special-purpose computer;
storing the record of the T2 markings' measurements and location L1 in the memory unit;
determining which, if any, of the L1 at T2 marking's measurements indicate markings which require different retroreflectivity or width to be compliant with the runway's location L1 marking requirements by comparing the L1 at T2 marking's measurements with location L1's marking requirements;
comparing the L1 at T1 markings' measurements and the L1 at T2 markings' measurements to determine differences, if any, between the L1 at T1 markings' measurements and the L1 at T2 markings' measurements, and determining the temporal difference between T1 and T2, and using the measurement differences and the temporal difference to determine absolute measurement changes from T1 to T2 and the rates of measurement changes from T1 to T2;
using the measurements and the rates of measurement changes to project when the runway's markings' measurements at L1 will be cease being compliant with the L1's marking requirements; and
scheduling removal and replacement of the L1 marking for before the L1 marking ceases to be compliant with the L1's marking requirements.

11. The method of claim 10 further comprising:
repeating the steps of claim 10 at runway marking locations 2 . . . n (L2 . . . n);
for at least some individual multiple separate marking locations L2 . . . n, project when the locations will cease being compliant with the runway's marking requirements at those locations;
using the separate marking compliance projections to identify first runway marking portions which will require maintenance to be compliant with the airfield runway marking requirements before other second runway marking portions; and
scheduling removal and replacement of the first runway marking portions before removal and replacement of the second runway markings portions.

12. The method of claim 10, wherein the runway marking requirements are FAA marking requirements.

13. The method of claim 10 wherein the period of time between T1 to T2 is at least 6 months.

14. The method of claim 10 wherein the period of time between T1 to T2 is at least one year.

15. The method of claim 10 wherein the period of time between the scheduled removal and replacement of the first runway markings portions and the scheduled repair and replacement of the second runway markings portions is at least 6 months.

16. The method of claim 12 wherein the period of time between the scheduled repair and replacement of the first runway markings portions and the scheduled repair and replacement of the second runway markings portions is at least one year.

17. The method of claim 12 further comprising:
repeating the steps of claim 11 at multiple other airports' runways markings;
collecting the other airports' runways markings and the first airport's runway marking measurements in a general or special-purpose computer;
comparing the other airports' runways actual marking measurements with the first airport's markings measurements and projections; and
grouping similar other runways' markings measurements and the first airport's runways runway marking measurements and using the similar actual runway marking measurements to adjust the first airport's markings projections toward the other similar actual runway's markings measurements;
using the adjusted first airport marking projections to identify first airport runway marking portions which will require maintenance to be compliant with the first airfield's runway marking requirements before other second runway marking portions; and
scheduling removal and replacement of the first runway marking portions before removal and replacement of the second runway markings portions.

18. The method of claim 12 further comprising setting minimum compliance thresholds for different types of measurements, and producing a report signaling the location of markings whose measurements are less than the threshold measurements.

19. An apparatus for determining when different portions of a first airport runway's markings will be cease being compliant with predetermined airport runway marking requirements, comprising:
a mobile platform for moving above an airport runway marking;
measurement modules comprising a retroreflectivity module for measuring marking retroreflectivity, a width module for measuring marking width, a location module for identifying the measured marking location, and a recording module for recording the retroreflectivity, width and location measurements, the measurement modules being connected to the mobile platform;
a guidance module capable of using the runway marking to guide the mobile platform along the runway marking, the guidance module being attached to the mobile platform;
a visual image module capable of taking visual images of runway markings;
a general-purpose or special-purpose computer for creating a record of the T1 marking's measurements at location L1;
a memory unit for storing the record of the T1 markings measurements and visual images and location L1;
the computer being capable of determining which, if any, of the L1 at T1 marking's measurements indicate markings which require different retroreflectivity or width to be compliant with the runway's location L1 marking requirements by comparing the L1 at T1 marking's measurements with location L1's marking requirements;
the computer being capable of recording T2 marking measurements at the location L1 at a Time 2 (“T2”), which is after T1, creating a record of the T2 marking measurements;
the memory unit being capable of storing the record of the T2 markings' measurements and visual images and location L1;
the computer capable of determining which, if any, of the L1 at T2 marking's measurements indicate markings which require different retroreflectivity or width to be compliant with the runway's location L1 marking requirements by comparing the L1 at T2 marking's measurements with location L1's marking requirements, comparing the L1 at T1 markings' measurements and the L1 at T2 markings' measurements to determine differences, if any, between the L1 at T1 markings' measurements and the L1 at T2 markings' measurements, and determining the temporal difference between T1 and T2, and using the measurement differences and the temporal difference to determine absolute measurement changes from T1 to T2 and the rates of measurement changes from T1 to T2, using the measurements and the rates of measurement changes to project when the runway's markings' measurements at L1 will be cease being compliant with the L1's marking requirements; and scheduling removal and replacement of the L1 marking for before the L1 marking ceases to be compliant with the L1's marking requirements; and
a visual display capable of visually displaying at least some of the different runway markings measurements and when at least some of the different projected times at which at least some of the different runway marking locations L1 . . . n will cease being compliant with the runway marking requirements, and capable of visually displaying captured visual images of individual different runway marking locations L1 . . . n together with the individual runway marking locations L1 . . . n measurements.
